(19) United States
(12) Patent Application Publication
(10) Pub. No.: US 2008/0106421 A1
(43) Pub. Date: May 8, 2008

(54) Infant sleep position monitoring system and method

(76) Inventors: Jerad D. Adams, Avon, IN (US); Frank J. David, Avon, IN (US)

Correspondence Address: BARNES & THORNBURG LLP, 600 ONE SUMMIT SQUARE, FORT WAYNE, IN, 46802, US

(21) Appl. No.: 11/593,397

(22) Filed: Nov. 6, 2006

(51) Int. Cl. G08B 21/02

(52) U.S. Cl. 340/573.1

(57) ABSTRACT

A system and method for detecting when an infant has rolled over onto his/her stomach. The system uses radio frequency identification (“RFID”) in some embodiments.

### TECHNICAL FIELD

The present invention relates to a system and method for detecting when an infant rolls onto his/her stomach.

### BACKGROUND

The sleep position of an infant is extremely important. If the infant lies on his/her stomach (also known as the prone position), the risk of sudden infant death syndrome (“SIDS”) greatly increases. SIDS, the leading cause of death for babies between the ages of one month to one year, is a condition in which an apparently healthy infant is suddenly and unexpectedly found dead in bed for no apparent cause. Due to the increased risk of SIDS associated with infants lying on their stomachs, pediatricians strongly recommend that infants be placed on their backs.

Although a caregiver may place an infant on his/her back, there is a risk that the infant will roll over to the potentially dangerous prone position. If this happens, the infant may lack sufficient strength to roll over to his/her back. Accordingly, the risk that the infant will suffer from SIDS increases.

Monitoring systems have been developed to detect when an infant rolls onto his/her stomach. For example, U.S. Pat. No. 5,914,660 to Mesibov describes an optical sensor that interacts with a reflective marker adhered to an infant. The optical sensor determines the infant's position based on the amount of reflected light. In U.S. Pat. No. 6,280,392 to Yoshimi, the system uses a pressure sensitive sheet. The infant's position is determined by the pressure pattern on the sheet. Although these systems indirectly detect the infant's position, they do not detect when an infant's chest (or other portion of the infant's front torso) comes into close proximity with the mattress. Accordingly, there is a need for an improved monitoring system that detects when an infant moves to his/her stomach.

### SUMMARY

According to one aspect, the invention provides a system for detecting when an infant rolls onto his/her stomach. In one embodiment, the system includes a radio frequency transmitter and an alarm circuit. The transmitter would typically be coupled to either the infant's clothing or diaper and transmit a radio frequency signal when the distance between the transmitter and the mattress becomes less than a predetermined distance. The alarm circuit generates an alarm signal responsive to receiving the radio frequency signal. In some cases, the transmitter transmits the radio frequency signal when the transmitter becomes closer to the mattress than the distance between the infant's chest and back, such as approximately two inches.

In some cases, the system includes a planar antenna configured to receive the radio frequency signal. Preferably, the transmitter is adjacent the planar antenna when the infant lies on his/her stomach; whereas, the planar antenna and the transmitter are spaced apart by the infant when the infant lies on his/her back. In some embodiments, the transmitter could be configured to transmit a radio frequency signal indicative of a distance between the transmitter and the planar antenna becoming less than a predetermined distance. Typically, the planar antenna has a greater width than the width of the infant. Embodiments are contemplated in which the system includes a mat with a cavity dimensioned to receive the planar antenna.

In some embodiments, the system includes an antenna, a RFID tag and an alarm circuit. The antenna is associated with a surface on which an infant is lying and transmits a periodic or continuous interrogation signal. The RFID tag is associated with the infant and typically draws power from the interrogation signal. The RFID tag also transmits a return signal to the antenna responsive to receiving the interrogation signal. The alarm circuit is in electrical communication with the antenna and detects when the infant rolls onto his/her stomach based on the return signal. The alarm circuit also generates an alarm signal responsive to detection that the infant rolled onto his/her stomach. In some cases, the alarm signal could be an audible sound, a visual signal, and/or a vibration.

In some cases, the alarm circuit detects when the infant rolls onto his/her stomach by determining whether the RFID tag is less than a predetermined distance from the surface on which the infant is lying. For example, the alarm circuit could detect when the infant rolls onto his/her stomach by determining whether the RFID tag is less than approximately two inches from the surface.

In some embodiments, the system could include a protective sleeve dimensioned to receive the RFID tag. The protective sleeve could have a fastener portion that attaches the sleeve to clothing of the infant.

According to a still further embodiment, the system includes an antenna, a passive RFID tag, and an alarm circuit. The passive RFID tag is coupled to a front torso portion of the infant. The antenna is in electrical communication with the alarm circuit and establishes a read zone extending from a surface on which an infant is lying. The alarm circuit detects when the passive RFID tag is in the read zone. This generates an alarm signal upon detection of the RFID tag in the read zone. In this embodiment, the read zone is dimensioned such that the passive RFID tag is in the read zone when the infant lies on his/her stomach, but not when the infant lies on his/her back. In some cases, the antenna could establish a read zone that does not extend beyond the infant's front torso. For example, the read zone could extend approximately two inches from the surface on which the infant is lying. In some cases, the read zone could have a width of approximately one to two feet.

According to another aspect, the invention provides a method for detecting when an infant rolls onto his/her stomach. The method includes the step of coupling a radio frequency transmitter to an infant. A radio frequency receiver is placed onto a surface and the infant placed on the receiver. Next, whether the radio frequency transmitter moves within a predetermined distance of the receiver will be detected. Upon detecting that the transmitter is less than the predetermined distance from the receiver, an alarm signal will be generated. In some embodiments, the transmitter could be a passive RFID tag and the receiver could include an antenna.

Additional features and advantages of the invention will become apparent to those skilled in the art upon consideration of the following detailed description of the illustrated embodiment exemplifying the best mode of carrying out the invention as presently perceived.

### BRIEF DESCRIPTION OF DRAWINGS

The present disclosure will be described hereafter with reference to the attached drawings which are given as non-limiting examples only, in which:

FIG. 1 is a perspective view of an embodiment of the system in use monitoring an infant;

FIG. 2 is a perspective view of a protective sleeve for holding the RFID tag according to an alternative embodiment;

FIG. 3 is a diagrammatic view of the system according to an embodiment of the invention;

FIG. 4 is a side cross-sectional view of the system shown in FIG. 1 with an infant lying on his/her back;

FIG. 5 is a side cross-sectional view of the system shown in FIG. 1 with the infant lying on his/her stomach; and

FIG. 6 is a flow chart showing a method for detecting when an infant rolls onto his/her stomach according to an embodiment of the invention.

Corresponding reference characters indicate corresponding parts throughout the several views. The exemplification set out herein illustrates example embodiments of the invention, and such exemplification is not to be construed as limiting the scope of the invention in any manner.

### DETAILED DESCRIPTION OF THE DRAWINGS

It is to be understood by one of ordinary skill in the art that the present discussion is a description of exemplary embodiments only, and is not intended as limiting the broader aspects of the present invention, which broader aspects are embodied in the exemplary constructions.

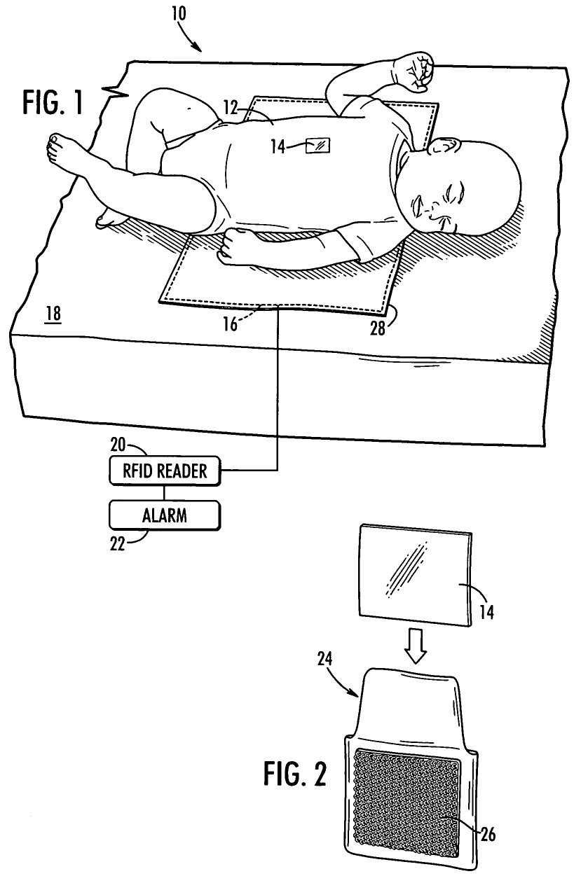

FIG. 1 illustrates a system 10 for detecting when an infant rolls over onto his/her stomach, in accordance with an embodiment of the present invention. Although the system 10 is described below using radio frequency identification (“RFID”) technology, embodiments are also contemplated in which other types of radio frequency transmitters and receivers could be used.

As shown in FIG. 1, the system 10 is in use with an infant 12 sleeping on his/her back. In this embodiment, the system 10 comprises a RFID tag 14 associated with the infant 12, an antenna 16 associated with a surface 18, such as a mattress, on which the infant 12 is lying, a RFID reader 20 configured to detect when the RFID tag 14 is within a certain proximity of the antenna 16, and an alarm 22 configured to generate an alarm signal when the infant 12 rolls onto his/her stomach. In some cases, the functionality of the alarm 22 may be integrated into the RFID reader 20. For example, hardware and/or software could be integrated into the RFID reader 20 to generate an alarm signal when the infant 12 rolls onto his/her stomach. It should be appreciated that the RFID reader 20 may include a built-in antenna. In such cases, a portion of the RFID reader 20 may be associated with the surface 18, such as positioned beneath the infant 12.

The RFID tag 14 is preferably a passive RFID tag. In such embodiments, the RFID tag 14 would not have an on-board power source. Instead, the RFID tag 14 would draw power from an interrogation signal periodically or continuously emitted from the antenna 16. In response to the interrogation signal, the RFID tag 14 would transmit a return signal. Since the RFID tag 14 would only “wake up” upon receiving the interrogation signal, the RFID tag 14 would not transmit a return signal outside the range of the interrogation signal. Thus, a return signal would indicate that the RFID tag 14 is within the range of the interrogation signal, which is a region referred to herein as the RFID reader's 20 “read zone.” As discussed below, the presence of the RFID tag 14 in the “read zone” could indicate that the infant 12 rolled onto his/her stomach.

In some embodiments, the RFID tag 14 could be a semi-active RFID tag. In such embodiments, the RFID tag 14 could include an on-board power source for certain operations; however, the RFID tag 14 would draw power from an interrogation signal to transmit a return signal. Accordingly, as with embodiments in which the RFID tag 14 is a passive RFID tag, a return signal would indicate that the RFID tag 14 is within the range of the interrogation signal, which could indicate that the infant 12 rolled onto his/her stomach.

Embodiments are also contemplated in which the RFID tag 14 could be an active RFID tag. In such embodiments, the RFID tag 14 would include an on-board power source (e.g., battery, solar power, etc.). With an on-board power supply, the active RFID tag could transmit data to the RFID reader 20 independent of receiving an interrogation signal.

The RFID tag 14 could be formed in any suitable manner, including but not limited to chip-based and printed tags. Embodiments are contemplated in which the RFID tag 14 could be silicone-based, polymer-based, or carbon-based (i.e., organic). The particular type of materials and/or manufacturing techniques used to form the RFID tag 14 is not important to the present invention.

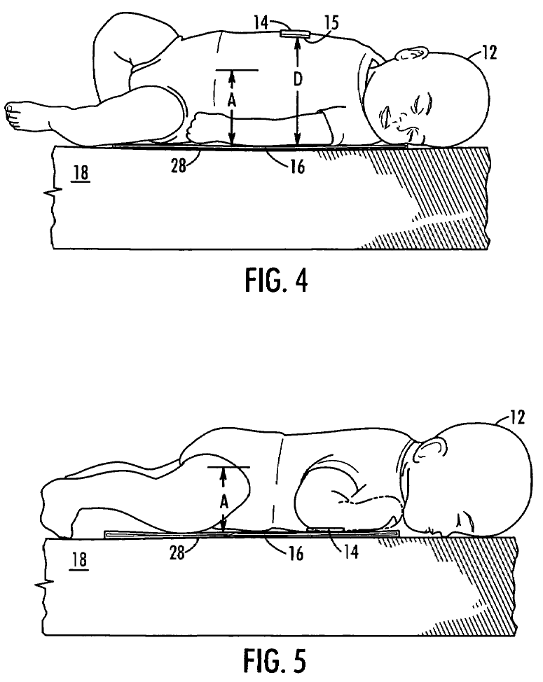

In the embodiment shown in FIG. 1, the RFID tag 14 includes an adhesive portion 15 (see FIG. 4) for coupling the RFID tag 14 to the infant 12. Preferably, the RFID tag 14 is coupled to the front torso of the infant 12. The term “torso” means the infant's body excluding the head, neck and limbs. Although the front torso is preferred, it should be appreciated that the RFID tag 14 could be coupled to other portions of the infant's body, such as the front portion of the thighs or knees. In some cases, the RFID tag 14 may be coupled to the infant 12 via the clothing or diaper of the infant 12. In some cases, a plurality of RFID tags 14 could be provided, such as a roll or sticker page(s) of RFID tags 14. In such embodiments, the RFID tag 14 could be discarded after each use.

FIG. 2 shows an alternative embodiment in which the RFID tag 14 may be placed in a protective sleeve 24. As shown, the protective sleeve 24 includes hook and loop fasteners 26 to couple the protective sleeve 24 to the clothing of the infant 11. Other embodiments of the protective sleeve 24 are also contemplated with other types of fasteners, such as a safety pin or adhesive.

The terms “couple” and “coupled” are intended broadly to encompass both direct and indirect coupling. Thus, the RFID tag 14 and the infant 12 are said to be coupled together when they are directly connected (e.g., by direct contact of the RFID tag 14 with the skin of the infant 12), as well as when the RFID tag 14 and the infant 12 are indirectly coupled (e.g., by attaching the RFID tag to an item associated with the infant 12, such as the infant's clothing or diaper). Accordingly, the RFID tag 14 is coupled to the infant 12 in both the embodiment shown in FIG. 1 in which the RFID tag 14 is attached to the infant's clothing and in the embodiment shown in FIG. 2 in which the protective sleeve 24 carrying the RFID tag 14 is attachable to the infant's 12 clothing.

Referring again to FIG. 1, the antenna 16 establishes a read zone for the RFID reader 20. The read zone is the region extending from the antenna 16 in which the RFID reader 20 can detect the RFID tag 14. If the RFID tag 14 is outside the read zone, the RFID reader 20 cannot detect the RFID tag 14; conversely, the RFID reader 20 can detect the RFID tag 14 if in the read zone. For example, the read zone may be the region in which the interrogation signal emanates from the antenna 16 in embodiments in which the RFID tag 14 is either a passive or semi-active RFID tag. Preferably, the read zone is configured such that the RFID tag 14 is outside the read zone when the infant 12 is lying on his/her back, but within the read zone when the infant 12 is lying on his/her stomach. By way of example only, the read zone may extend less than approximately two inches from the antenna 16 in one embodiment. By way of another example, the read zone may have a width of approximately one to two feet in some embodiments. As shown, the antenna 16 extends transversely a greater width than that of the infant's 12 torso. In the example shown, the antenna 16 is a planar antenna that extends substantially the entire length of the infants' 12 torso. It should be appreciated that the antenna 16 could be two or more antennas in electrical communication with the RFID reader 20.

In some embodiments, the RFID tag 14, antenna 16, and RFID reader 20 may be selected as off the shelf parts and tuned to create a desired read zone. For example, the RFID tag 14 may be selected based on the distance to be read and the desired size of the RFID tag 14. The antenna 16 could be selected based on the desired distance and area need to recognize the RFID tag 14, for example. In some cases, the antenna 16 may be tuned based on the read zone and the desired physical dimensions of the antenna 16, such as by selecting the number of windings and/or pattern of the antenna 16, for example. In some cases, the antenna 16 may be selected and tuned based on the frequency of the RFID reader 20.

In the example shown in FIG. 1, a mat 28 is provided with a cavity dimensioned to receive the antenna 16. In some cases, the cavity may be substantially water-proof to prevent fluid from coming into contact with the antenna 16. The mat 28 would typically include a cushioned portion for the comfort of the infant 12. In some cases, the mat 28 could be rolled up to reduce packaging space and/or for storage. It should be appreciated, however, that embodiments are contemplated in which the antenna 16 could be positioned below other cushioning layer(s), such as sheets, blankets, or a mattress pad, instead of (or in addition to) the mat 28.

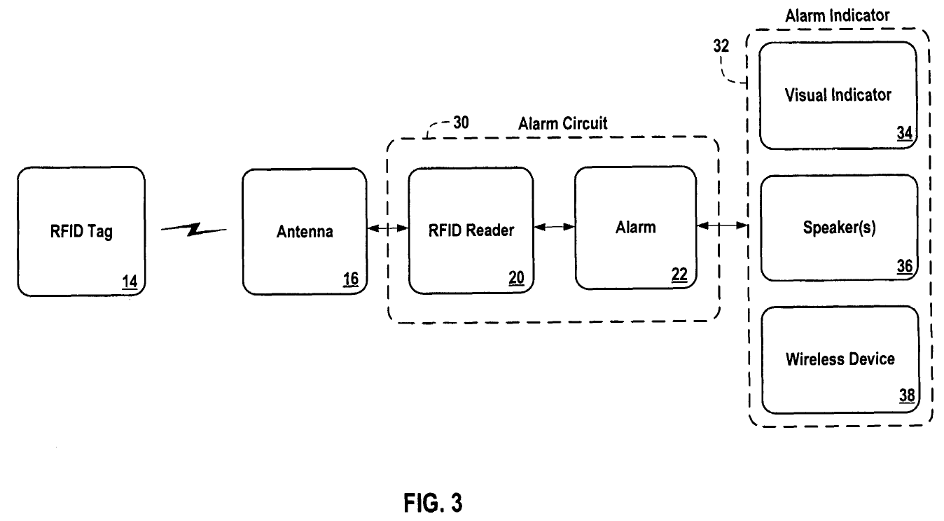

FIG. 3 shows a diagrammatic representation of the system 10 shown in FIG. 1. The antenna 16 wirelessly communicates with the RFID tag 14 if the RFID tag 14 is within the read zone. For example, in an embodiment in which the RFID tag 14 is a passive or semi-active RFID tag, the RFID reader 20 could transmit an interrogation signal through the antenna 16, which would be received by the RFID tag 14 if in the read zone. In response to receiving the interrogation signal, the RFID tag 14 would transmit a return signal. As discussed above, the interrogation signal may be continuously transmitted or periodically communicated. Although the antenna 16 is shown as a separate component in FIG. 3, the antenna 16 could be integrated into the RFID reader 20 in some embodiments.

In the example shown, the RFID reader 20 is in communication with the alarm 22 to define an alarm circuit 30. As discussed above, the RFID reader 20 may be capable of generating an alarm signal in some embodiments; in such embodiments, the separate alarm 22 would be optional. The alarm 22 (or RFID reader 20 in embodiments without the alarm 22) is in communication with an alarm indicator 32 that is configured to provide an indication to a caregiver (not shown) that the infant 12 rolled over to his/her stomach. In some embodiments, the alarm indicator 32 may be configured to awaken the infant 12. For example, a portion of the mat 28 may vibrate if the infant 12 rolls over to his/her stomach, which would awaken the infant. It should be appreciated that the electrical communication between the antenna 16, RFID reader 20, alarm 22 and alarm indicator 32 may be wired, wireless, fiber optic, and/or other type of electrical (or software) coupling.

The alarm indicator 32 may be on board the alarm 20 or may be a separate device or devices in communication with the alarm 20. The alarm indicator 32 may include, as examples, a visual indicator 34, such as a flashing light, one or more speakers 36, and/or a wireless device 38, such as a baby monitor. When the alarm 22 generates an alarm signal, the mat 28 may vibrate and a speaker in the infant's room may sound an alarm to awaken the infant, while at the same time a baby monitor in the caregiver's room may sound an alarm and flash a light, for example.

FIGS. 4 and 5 show side cross-sectional views of the system 10 shown in FIG. 1, with the infant 12 lying on his/her back and stomach, respectively. As shown, the infant 12 is lying on the mat 28, which includes the antenna 16. The distance “D” represents a maximum distance that the torso of the infant 12 extends above the mat 28. As shown, a RFID tag 14 has been attached to the chest area of the infant 12. Although the RFID tag 14 is placed on the chest area of the infant 12 in the example shown, the RFID tag 14 could be placed anywhere on the front of the infant's 12 body, such as the diaper area, thighs, knees, shoulders, etc. With the placement of the RFID tag 14 shown, the RFID 14 is spaced apart from the mat 28 the distance “D” in FIG. 4. The read zone of the antenna 16 could be set to the distance “D” across the mat 28. Accordingly, if the distance between the RFID tag 14 and the antenna 16 became less than the distance “D,” this would indicate that the infant 12 rolled over to his/her side or stomach.

In some cases, however, the RFID tag 14 may be closer to the antenna 16 than the distance “D” even if the infant 12 does not roll onto his/her stomach, such as if the RFID tag 14 were placed in a portion of the front torso that is lower than the distance “D,” such as on the front of the infant's diaper, or if the infant were a smaller size. Accordingly, to prevent false alert signals, the read zone could extend a predetermined distance “A” from the mat 28, which would be less than the distance “D.” In such embodiments, the RFID tag 14 would enter the read zone when the RFID tag 14 became closer to the antenna 16 than the distance “A”. In response to the RFID tag 14 entering the read zone, the RFID reader 20 would detect that the infant 12 rolled onto his/her stomach and the alarm 22 would generate an alarm signal. In some embodiments, the distance “A” could be significantly less than the typical distance that an infant's torso extends from the mat, such as half the typical distance, to prevent false alarms. By way of example only, the distance “A” may be approximately two inches in one embodiment.

FIG. 5 shows the system 10 of FIG. 4 when the infant 12 rolls over to his/her stomach. As shown, the distance between the RFID tag 14 and the antenna 16 is less than the distance “A.” Accordingly, the RFID reader 20 would detect that the infant 12 rolled over to his/her stomach.

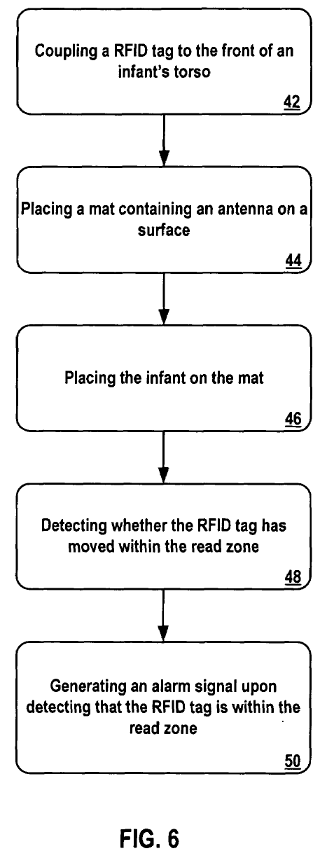

Referring now to FIG. 6, a method of detecting when an infant rolls onto his/her stomach will be described. The RFID tag 14 is coupled to the front of the infant's 12 torso, such as via the infant's 12 clothing or diaper, as shown by step 42. In some cases, the RFID tag 14 may be separated from a roll of RFID tags or removed from a sticker book of RFID tags.

The mat 28 with the antenna 16 is placed on a surface on which the infant 12 will lie, such as the infant's mattress, as indicated by step 44. In embodiments without the mat 28, the antenna 16 may be placed on the surface. In such embodiments, it should be appreciated that the antenna 16 could be positioned below the sheet(s) and/or other cushioning layer(s), such as a mattress pad, for the comfort of the infant 12.

The infant 12 is then placed on the mat 28, as indicated by step 46. The order of steps 42 and 46 is not important. In order words, it does not matter whether the RFID tag 14 is coupled to the infant 12 prior to or after the infant 12 is placed on the mat 28. Next, whether the RFID tag 14 has moved within the read zone of the antenna 16 is detected, as indicated by step 48. Upon detecting that the RFID tag is within the read zone of the antenna 16, an alarm signal is generated.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A system for detecting when an infant rolls onto his/her stomach, the system comprising:
a transmitter adapted to be coupled to an infant, wherein the transmitter is configured to transmit a radio frequency signal when a distance between the transmitter and a surface on which the infant is lying becomes less than a predetermined distance; and
an alarm circuit configured to receive the radio frequency signal from the transmitter and generate an alarm signal responsive to receiving the radio frequency signal.

2. The system of claim 1, wherein the predetermined distance is less than a distance between the infant's chest and back.

3. The system of claim 1, wherein the predetermined distance is approximately two inches.

4. The system of claim 1, further comprising a planar antenna configured to receive the radio frequency signal, wherein the planar antenna is in electrical communication with the alarm circuit.

5. The system of claim 4, wherein the transmitter is configured to transmit a radio frequency signal indicative of a distance between the transmitter and the planar antenna becoming less than a predetermined distance.

6. The system of claim 5, wherein the planar antenna is dimensioned to have a width greater than the width of the infant.

7. The system of claim 4, further comprising a mat having a cavity dimensioned to receive the planar antenna.

8. The system of claim 7, wherein the mat includes a cushioned portion.

9. The system of claim 4, wherein the transmitter is adjacent the planar antenna when the infant lies on his/her stomach.

10. The system of claim 9, wherein the planar antenna and the transmitter are spaced apart by the infant when the infant lies on his/her back.

11. A system for detecting when an infant rolls onto his/her stomach, the system comprising:
an antenna configured to transmit an interrogation signal, wherein the antenna is associated with a surface on which an infant is lying;
a RFID tag associated with the infant, wherein the RFID tag is adapted to draw power from the interrogation signal and transmit a return signal to the antenna;
an alarm circuit adapted to be in electrical communication with the antenna;
wherein the alarm circuit is configured to detect when the infant rolls onto his/her stomach based on the return signal; and
wherein the alarm circuit is configured to generate an alarm signal responsive to detection that the infant rolled onto his/her stomach.

12. The system of claim 11, wherein the alarm circuit is configured to detect when the infant rolls onto his/her stomach by determining whether the RFID tag is less than a predetermined distance from the surface.

13. The system of claim 11, wherein the alarm circuit is configured to detect when the infant rolls onto his/her stomach by determining whether the RFID tag is less than approximately two inches from the surface.

14. The system of claim 11, further comprising a protective sleeve dimensioned to receive the RFID tag, wherein the protective sleeve includes a fastener portion attachable to clothing of the infant.

15. The system of claim 14, wherein the fastener portion includes hook and loop fasteners.

16. The system of claim 11, further comprising a mat defining an interior cavity dimensioned to receive the antenna.

17. The system of claim 16, wherein the interior cavity is substantially water-proof.

18. The system of claim 16, wherein the mat is flexible about a transverse axis.

19. The system of claim 16, wherein the mat includes a cushioned portion.

20. The system of claim 11, wherein the alarm signal is at least one of the following: an audible sound, a visual signal, and a vibration.

21. A system for detecting when an infant rolls onto his/her stomach, the system comprising:
an antenna configured to establish a read zone extending from a surface on which an infant is lying;
a passive RFID tag adapted to be coupled to a front torso portion of the infant;
an alarm circuit adapted to be in electrical communication with the antenna, wherein the alarm circuit is configured to detect when the passive RFID tag is in the read zone and generate an alarm signal responsive to detection of the RFID tag in the read zone; and
wherein the read zone is dimensioned such that the passive RFID tag is in the read zone when the infant lies on his/her stomach, but not when the infant lies on his/her back.

22. The system of claim 21, wherein the antenna is configured to establish a read zone that extends a distance from the surface on which the infant is lying that is less than a distance that the infant's front torso portion extends from the surface.

23. The system of claim 21, wherein the antenna is configured to establish a read zone that extends approximately two inches from the surface on which the infant is lying.

24. The system of claim 23, wherein the antenna is configured to establish a read zone with a width of approximately one to two feet.

25. The system of claim 24, wherein the antenna is configured to establish a read zone that extends substantially the entire length of the torso portion of the infant.

26. A system for detecting when an infant rolls onto his/her stomach, the system comprising:
means for establishing a read zone extending from a surface on which an infant is lying, wherein the read zone extends a distance from the surface that is less than a distance that the infant's front torso extends from the surface;
means for detecting when at least a portion of the infant's front torso enters the read zone; and
means for generating an alarm signal responsive to the detecting means.

27. The system of claim 26, wherein the read zone has a width of approximately one to two feet.

28. The system of claim 27, wherein the read zone has a length that is substantially the entire length of the infant's torso.

29. The system of claim 28, wherein the read zone extends approximately two inches from the surface.

30. A method for detecting when an infant rolls onto his/her stomach, the method comprising the steps of:
coupling a radio frequency transmitter to an infant;
placing a radio frequency receiver onto a surface;
placing the infant onto the radio frequency receiver;
detecting whether the radio frequency transmitter moves within a predetermined distance of the receiver; and
generating an alert signal upon detecting that the transmitter is less than the predetermined distance from the receiver.

31. The method of claim 30, wherein the transmitter is a passive RFID tag.

32. The method of claim 31, wherein the receiver comprises an antenna.

33. The method of claim 32, wherein the passive RFID tag is coupled to the front torso of the infant.

34. The method of claim 32, wherein the coupling step includes placing the passive RFID tag into a protective sleeve dimensioned to receive the passive RFID tag and coupling the protective sleeve to the infant.

35. The method of claim 32, further comprising the step of separating the passive RFID tag from a plurality of passive RFID tags.
